(19) United States
(12) Patent Application Publication
(10) Pub. No.: US 2013/0056920 A1
(43) Pub. Date: Mar. 7, 2013

(54) CLAMPING DEVICE

(71) Applicants: Jun Watari, Tokyo (JP); Masato Honzawa, Tokyo (JP); Munehiro Nakamura, Tokyo (JP)

(72) Inventors: Jun Watari, Tokyo (JP); Masato Honzawa, Tokyo (JP); Munehiro Nakamura, Tokyo (JP)

(73) Assignee: HONDA MOTOR CO., LTD., Minato-ku, Toyoko (JP)

(21) Appl. No.: 13/697,181

(22) PCT Filed: Feb. 1, 2011
(86) PCT No.: PCT/JP2011/052055

§ 371 Date: Nov. 9, 2012

(30) Foreign Application Priority Data
May 12, 2010 (JP) 2010-109944

(51) Int. Cl. B23Q 3/06; B23Q 1/64; B23Q 3/04

(52) U.S. Cl. 269/58; 269/216; 269/265

(57) ABSTRACT

Provided is a clamping device such that improvement can be made in the degree of freedom of machining and the degree of freedom in dealing with the shape of the workpiece. This clamping device (1) serves to secure the workpiece, and is provided with a first grip section (12) which is disposed on an inner surface of a frame body (11) and has a plurality of protrusions (123) that project inward; a second grip section (13) which is disposed on a different inner surface of the frame body (11) and has a plurality of protrusions (133) that project inward, said different inner surface facing the inner surface whereon the first grip section (12) is disposed; and a grip section driving section (14) which moves the first grip section (12) and the second grip section (13) in a direction approaching each other or in a direction moving away from each other.

### TECHNICAL FIELD

The present invention relates to a clamping device.

### BACKGROUND ART

Conventionally, workpieces such as cylinder heads and cylinder blocks constituting the engine of a vehicle have been fixed to a jig pallet by a clamping device such as an arm clamp or hole clamp provided to this jig pallet, and then machined. In other words, when machining a workpiece, first, the workpiece is fixed to a jig pallet by the clamping device in a state placed on the jig pallet so that the machined surface of this workpiece is a top surface. Next, predetermined machining is conducted on the machined surface of the workpiece by way of a machining device such as an NC device (e.g., refer to Patent Document 1).

Patent Document 1: Japanese Patent Publication No. 3064043

### DISCLOSURE OF THE INVENTION

### Problems to be Solved by the Invention

However, with the aforementioned technique, machining is conducted on the top surface of the workpiece in a state in which the workpiece is fixed to a jig pallet. For this reason, when machined surfaces are present on the two surfaces of a first surface of the workpiece and a second surface located on an opposite side to this first surface, for example, machining is carried out in the following way.

First, the workpiece is fixed to the jig pallet by a clamping device in a state placing the workpiece on the jig pallet so that the first surface is the top surface, and then machining is conducted on the first surface. Next, the workpiece is placed on the jig pallet again so that the second surface is the top surface, the workpiece is fixed to the jig pallet again by the clamping device, and machining is conducted on the second surface.

With the above technique, when conducting machining on two machined surfaces of a workpiece in this way, a step of placing the workpiece on the jig pallet again has been necessary. In addition, with the above technique, since the suitable arrangement of the clamping device on the jig pallet differs depending on the size and shape of the workpiece, it has been necessary to use a jig pallet of a dedicated arrangement of clamping devices in accordance with the size and shape of the workpiece. In other words, with the conventional clamping device, the degrees of freedom in machining workpieces and the degrees of freedom in handling shapes of workpieces have been low.

Therefore, the present invention has an object of providing a clamping device that can improve the degrees of freedom in machining workpieces and the degrees of freedom in handling shapes of workpieces.

### Means for Solving the Problems

The present invention relates to a clamping device for fixing a workpiece, the device including: a frame body capable of surrounding the workpiece; a first grip section disposed at an inner surface of the frame body and having a plurality of projections that project inwards; a second grip section disposed at an inner surface of the frame body facing the inner surface on which the first grip section is disposed, and having a plurality of projections that project inwards; and a grip-section drive unit that causes the first grip section and the second grip section to advance or retract in a direction approaching or a direction separating from each other.

In addition, it is preferable for the workpiece to include at least one machined surface, and a peripheral surface including a first gripped surface extending substantially perpendicular to the machined surface, and a second gripped surface that extends substantially perpendicular to the machined surface and substantially parallel to the first gripped surface; the frame body to surround the peripheral surface of the workpiece; the first grip section to be disposed to face the first gripped surface; and the second grip section to be disposed to face the second gripped surface.

Furthermore, it is preferable for the clamping device to further include a frame body drive unit that is connected to the frame body, and causes the frame body to rotational drive to be changeable between a horizontal state in which the machined surface follows a horizontal direction and a vertical state in which the machined surface follows a vertical direction.

Additionally, it is preferable for the workpiece to include a plurality of reference parts provided on the machined surface, and the clamping device to further include: a probe unit capable of contacting the plurality of reference parts by advancing and retracting relative to the machined surface; and a positional information acquisition part that acquires positional information for each of the plurality of reference parts, based on contact positions between the probe unit and the plurality of reference parts.

Moreover, it is preferable for the clamping device to further include: a plane orientation detection part that detects a plane orientation of the machined surface based on the positional information acquired by the positional information acquisition part; and a machined surface correction part that corrects the plane orientation of the machined surface based on the plane orientation detected by the plane orientation detection part.

In addition, it is preferable for the clamping device to further include: a reference position detection part that detects a machining reference position on the machined surface based on the positional information acquired by the positional information acquisition part; and a position adjustment part that adjusts a machining initial position of a workpiece machining device conducting machining on the machined surface, based on the machining reference position detected by the reference position detection part.

Furthermore, it is preferable for the clamping device to further include a washing unit that sprays a wash solution towards the first grip section and the second grip section.

Additionally, it is preferable for the first grip section and the second grip section to be disposed asymmetrically relative to the workpiece.

Moreover, the present invention relates to a gripper for a clamping device, the gripper including a plurality of projections and fixing a workpiece by pressing by way of the plurality of projections.

### Effects of the Invention

According to the clamping device of the present invention, it is possible to improve the degrees of freedom in machining workpieces and the degrees of freedom in handling shapes of workpieces.

### BRIEF DESCRIPTION OF THE DRAWINGS

FIG. 1 is a perspective view showing an embodiment of a clamping device of the present invention;

FIG. 2 is a view showing a state in which a workpiece is clamped by the clamping device shown in FIG. 1;

FIG. 3 is a plan view showing the clamping device in a state arranging a clamping device main body in a horizontal state;

FIG. 4 is a view showing a first grip section;

FIG. 5 is a view showing a second grip section;

FIG. 6 is a diagram viewing, from a first machined surface side, a cylinder head as an example of a workpiece to be clamped by the clamping device;

FIG. 7A is a diagram viewing the cylinder head shown in FIG. 6 from a first gripped surface side;

FIG. 7B is a diagram viewing the cylinder head shown in FIG. 6 from a second gripped surface side;

FIG. 8 is a functional block diagram showing the configuration of a control device;

FIG. 9A is a view showing a state of measuring a plane orientation of a machined surface of the cylinder head clamped by the clamping device shown in FIG. 1;

FIG. 9B is a view showing a state of correcting a plane orientation of the machined surface;

FIG. 9C is a view showing a state of detecting a machining reference position on the cylinder head for which the plane orientation of the machined surface has been corrected;

FIG. 9D is a view showing a state of conducting machining by a machining device on the machined surface of the cylinder head for which the machining reference position was detected; and

FIG. 10 is a diagram showing other shapes of the cylinder heads.

### EXPLANATION OF REFERENCE NUMERALS

1 clamping device
10 clamping device main body
11 frame body
12 first grip section
13 second grip section
14 grip-section drive unit
20 clamp support device (frame body drive unit)
30 washing device
40 probe unit
50 control device
51 positional information acquisition part
52 plane orientation detection part
53 machined surface correction part
54 reference position detection part
55 position adjustment part
60 machining device
71 first machined surface (machined surface)
72 second machined surface (machined surface)
73 first gripped surface
74 second gripped surface
75 reference seat (reference part)
76 reference hole (reference part)
122, 132 gripper
123, 133 projection

### PREFERRED MODE FOR CARRYING OUT THE INVENTION

Hereinafter, a preferred embodiment of a clamping device 1 of the present invention will be explained while referencing the drawings.

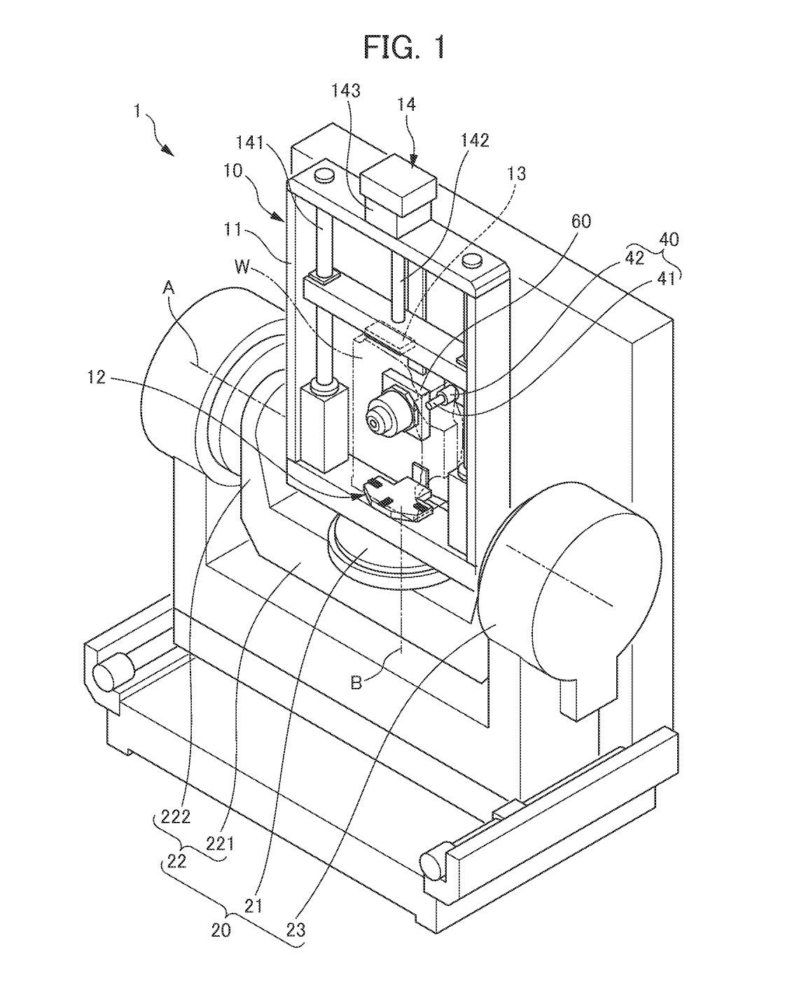

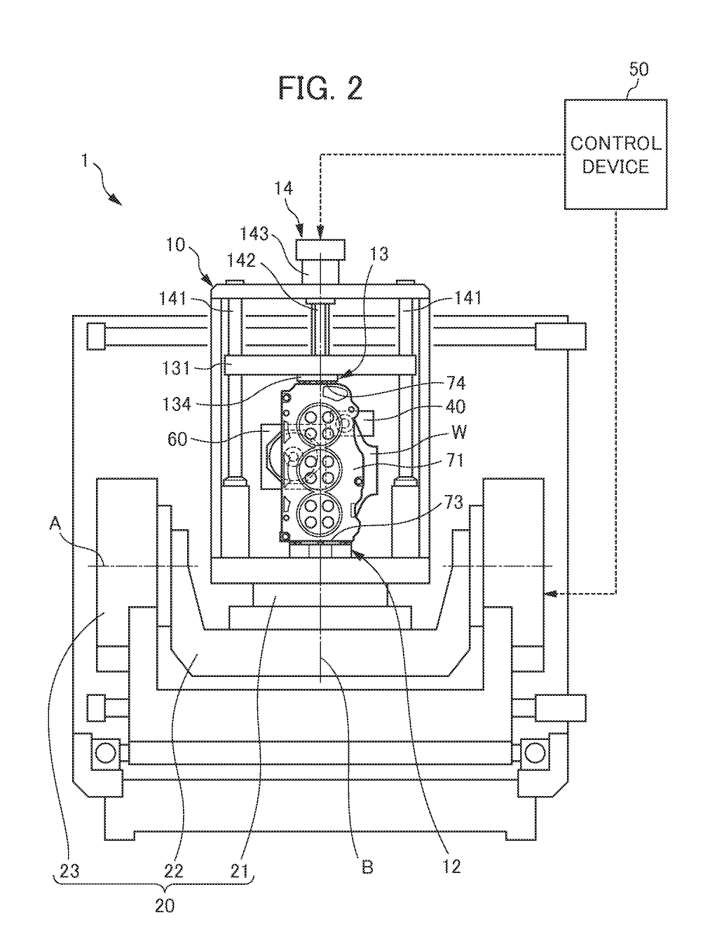

The clamping device 1 of the present embodiment is used when conducting machining by a workpiece machining device 60 such as an NC device on a workpiece such as the cylinder head or cylinder block configuring the engine of a vehicle, as shown in FIGS. 1 and 2. This clamping device 1 is arranged to oppose the workpiece machining device 60 in the manufacturing line of a vehicle.

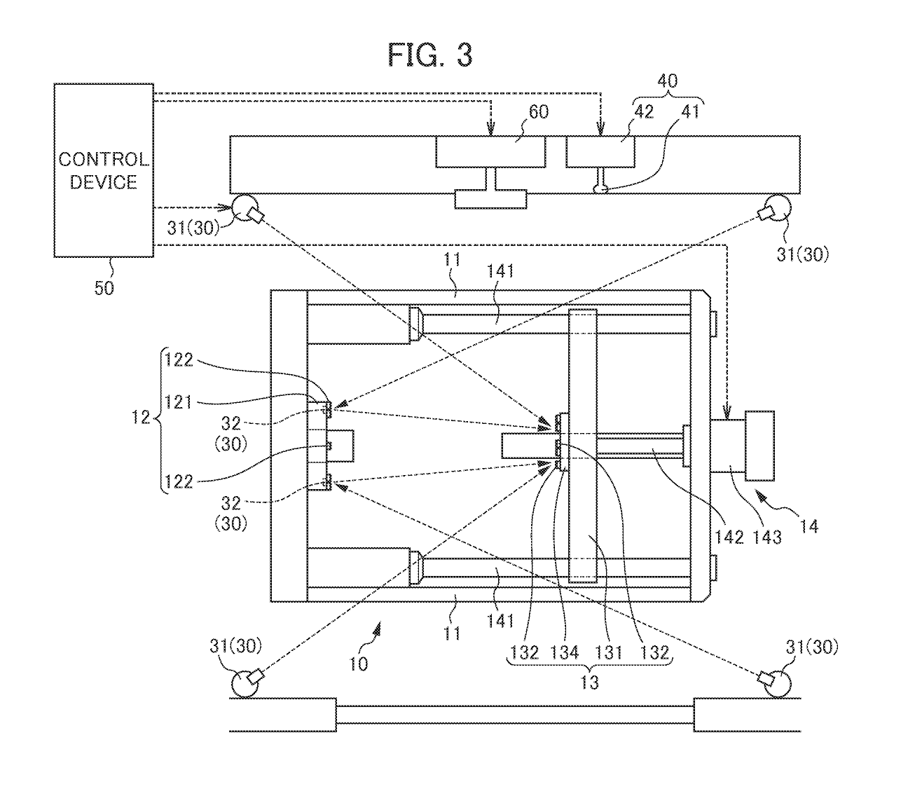

As shown in FIGS. 1 to 3, the clamping device 1 includes: a clamping device main body 10 that clamps a cylinder head W serving as a workpiece; a clamp support device 20 serving as a frame body driving part that causes this clamping device main body 10 to rotationally drive about a predetermined axis of rotation; a washing device 30 (refer to FIG. 3) serving as a washing unit that washes the clamping device main body 10; a probe unit 40 that detects positional information of the workpiece W clamped in the clamping device main body 10; and a control device 50 (refer to FIGS. 2 and 3) that controls the operations of this clamping device main body 10, clamp support device 20, washing device 30 and probe unit 40.

As shown in FIGS. 1 to 3, the clamping device main body 10 includes a frame body 11, a first grip section 12 that is disposed on an inner surface of this frame body 11, a second grip section 13 that is disposed on an inner surface of the frame body 11 facing the first grip section 12, and a grip-section drive unit 14 that drives the second grip section 13.

The frame body 11 is configured in a rectangular shape by metal members.

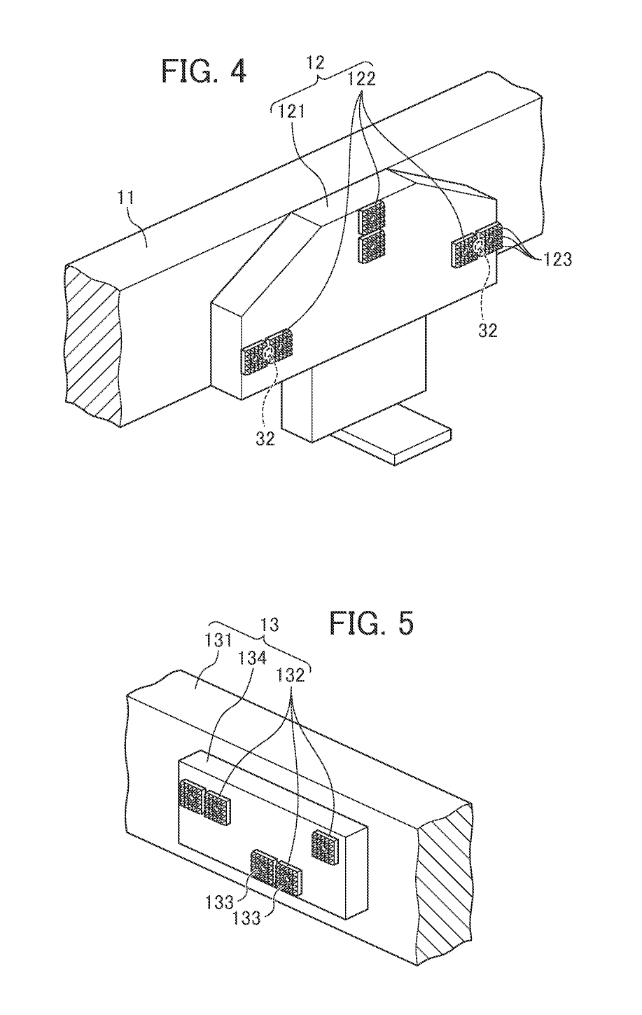

As shown in FIG. 4, the first grip section 12 includes a base 121 attached to the inner surface of the frame body 11, and a plurality of grippers 122 attached to this base 121. The base 121 is configured in a board shape, and is disposed at substantially the center of one inner surface of the frame body 11. At least three of the grippers 122 are disposed to be separated from each other at a surface of the base 121 facing inside of the frame body 11.

The plurality of grippers 122 is each configured to have a plurality of projections 123 for which the leading end configured by a metal component tapers to a point. For this plurality of grippers 122, the leading end side of the plurality of projections 123 is disposed towards inside of the frame body 11.

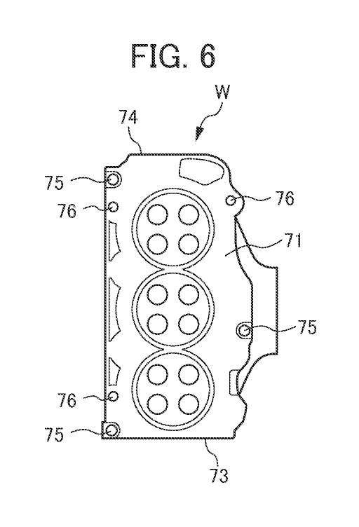

As shown in FIG. 5, the second grip section 13 includes a first base 131 disposed at an inner surface side of the frame body 11, a second base 134 fixed at a face of this first base 131 facing inside of the frame body 11, and a plurality of grippers 132 attached to this second base 134. The first base 131 is configured in a board shape having a substantially equal length to the length in the longitudinal direction of the inner surface of the frame body 11 on which this first base 131 is disposed. The second base 134 is disposed at substantially the center of the first base 131. At least three of the grippers 132 are disposed to be separated from each other on a surface of the second base 134 facing inside of the frame body 11.

The plurality of grippers 132 is each configured to have a plurality of projections 133 for which a leading end configured by a metal component tapers to a point. For this plurality of grippers 132, the leading end side of the plurality of projections 133 is disposed towards inside of the frame body 11.

The plurality of grippers 132 of this second grip section 13 is disposed at asymmetric positions to the plurality of grippers 122 of the first grip section 12 (positions not matching in the opposing direction between the first grip section 12 and the second grip section 13).

The height of each of the plurality of projections 123 of the first grip section 12 and the height of each of the plurality of projections 133 of the second grip section 13 are set to appropriate optimum values from the viewpoint of reducing the clamping marks formed on the workpiece W while favorably gripping this workpiece W clamped by the clamping device 1.

As shown in FIGS. 1 to 3, the grip-section drive unit 14 includes a pair of support members 141 that support the second grip section 13, a piston 142 that is connected to the second grip section 13, and a cylinder 143 that is connected to the frame body 11 and slidably houses the piston 142.

The pair of support members 141 is disposed along inner surfaces of the frame body 11 on which the first grip section 12 and the second grip section 13 are not disposed. The pair of support members 141 inserts into the vicinity of both ends in the longitudinal direction of the first base 131 of the second grip section 13.

The piston 142 is disposed so as to have an axial direction be substantially parallel to the pair of support members 141. A leading end side of this piston 142 is connected to a surface of the first base 131 of the second grip section 13 that is an opposite side to the surface thereof on which the grippers 132 are attached. A base end side of the piston 142 inserts into a through-hole (not illustrated) provided in the frame body 11 and is housed in the cylinder 143.

The cylinder 143 is connected to an exterior surface side of the frame body 11.

According to the above grip-section drive unit 14, when fluid is supplied into the cylinder 143 according to the control of the control device 50 described later, the piston 142 advances. The second grip section 13 thereby approaches the first grip section 12.

On the other hand, when fluid is discharged from inside of the cylinder 143 according to the control of the control device 50, the piston 142 retracts. The second grip section 13 thereby distances from the first grip section 12.

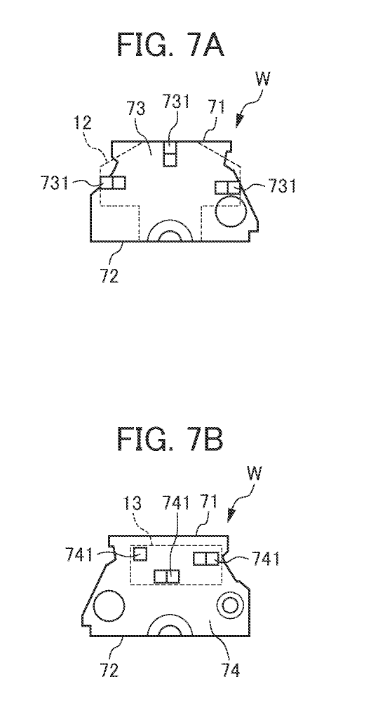

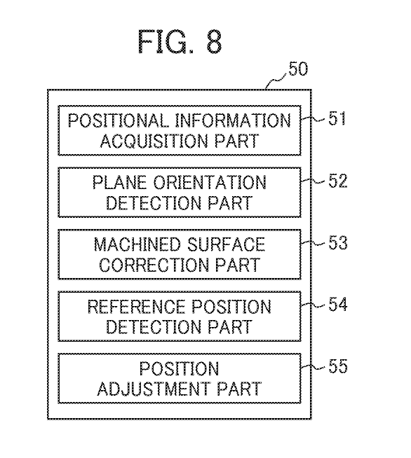

FIG. 6 is a diagram viewing, from a side of a first machined surface 71, the cylinder head W as one example of a workpiece clamped by the clamping device main body 10. FIG. 7A is a diagram viewing the cylinder head W from a side of a first gripped surface 73, and FIG. 7B is a diagram viewing the cylinder head W from a side of a second gripped surface 74.

The clamping device main body 10 of the present embodiment is used when clamping the cylinder head W as a workpiece.

As shown in FIG. 1 and FIGS. 6 to 7B, the cylinder head W is configured in a box shape that is thin in thickness, and includes the first machined surface 71 and a second machined surface 72 as machined surfaces, the first gripped surface 73 that extends substantially perpendicular to the first machined surface 71 and the second machined surface 72, and a peripheral surface including the second gripped surface 74 extending substantially perpendicular to the first machined surface 71 and second machined surface 72, and substantially parallel to the first gripped surface 73.

As shown in FIGS. 1 to 3, this cylinder head W is disposed so that the peripheral surface is surrounded by the frame body 11. In addition, as shown in FIG. 2, the cylinder head W is disposed so that the first gripped surface 73 faces the first grip section 12, and the second gripped surface 74 faces the second grip section 13. Then, in this state, the cylinder head W is clamped in the clamping device main body 10.

The first machined surface 71 and the second machined surface 72 configure two surfaces having wide surface area of the box-shaped cylinder head W. As shown in FIG. 6, three reference seats 75 and three reference holes 76 as reference parts are formed in the first machined surface 71.

The three reference seats 75 are provided to be distanced from each other in the vicinity of the edge of the first machined surface 71. These three reference seats 75 are formed on the first machined surface 71 to project slightly from other portions. These three reference seats 75 are used when measuring a plane orientation of the first machined surface 71 of the cylinder head W clamped in the clamping device main body 10.

The three reference holes 76 are also provided to be distanced from each other in the vicinity of the edge of the first machined surface 71. These three reference holes 76 are all configured as casting holes in the cylinder head W formed by casting. These three reference holes 76 are used when detecting the machining reference position in a case of conducting machine processing on the first machined surface 71 of the cylinder head W by the workpiece machining device 60.

Similarly to the first machined surface 71, three reference seats and three reference holes (none illustrated) are formed also in the second machined surface 72.

As shown in FIG. 2, the first gripped surface 73 and the second gripped surface 74 are configured by surfaces, among the peripheral surfaces of the cylinder head W, positioned on both end sides in the longitudinal direction of the first machined surface 71 and second machined surface 72, respectively.

As shown in FIG. 7A, flat portions 731 are formed at positions on the first gripped surface 73 corresponding to three grippers 122 of the first grip section 12, respectively.

As shown in FIG. 7B, flat portions 741 are formed at positions on the second gripped surface 74 corresponding to the three grippers 132 of the second grip section 13, respectively.

As shown in FIGS. 1 and 2, the clamp support device 20 includes a first table 21 that supports the clamping device main body 10, a second table 22 that supports this first table 21 to be rotatable about a first axis B orthogonal to a top surface of the first table 21, and a main body 23 that supports this second table 22 to be rotatable about a second axis A that is orthogonal to the first axis B and extends in a horizontal direction.

The first table 21 is configured in a disk shape. An outer surface of the frame body 11 corresponding to an inner surface on which the first grip section 12 is provided is fixed to the top surface of this first table 21.

The second table 22 includes a first support part 221 that supports the first table 21 to be able to revolve about the first axis B, and a pair of second support parts 222 that bends in the direction in which the first axis B extends from both ends of this first support part 221 in the direction in which the second axis A extends.

The main body 23 configures a base of the clamping device 1. This main body 23 supports the second table 22 at a leading end side of the pair of second support parts 222, and makes this second table 22 rotatable about the second axis A.

According to the above clamp support device 20, in a state attaching the clamping device main body 10 to the first table 21, it is possible to arrange the clamping device main body 10 at a desired attitude, by causing the first table 21 to rotate about the first axis B, and causing the second table 22 to rotate about the second axis A. For example, the clamping device main body 10 can be arranged in a horizontal state in which the frame body 11 follows the horizontal direction (refer to FIG. 3), or a vertical direction in which the frame body 11 follows the vertical direction (refer to FIG. 2).

As shown in FIG. 3, the washing device 30 includes a plurality of first wash solution spray units 31 disposed to be distanced from the clamping device main body 10 and clamp support device 20, and a second wash solution spray unit 32 provided to the first grip section 12.

The plurality of first wash solution spray units 31 is arranged at positions corresponding to the plurality of grippers 122, 132, respectively, in the horizontal state of the clamping device main body 10. The wash solution is sprayed from this plurality of first wash solution spray units 31 towards the corresponding grippers 122, 132, respectively. Foreign contamination such as metal powder adhered to the plurality of projections 123, 133 of the grippers 122, 132 is thereby removed.

As shown in FIG. 4, the second wash solution spray unit 32 is disposed in the vicinity of the grippers 122 on the base 121 of the first grip section 12. The wash solution is sprayed from the second wash solution spray unit 32 towards the plurality of grippers 132 of the second grip section 13 disposed to be facing thereto. Foreign contamination adhered to the plurality of projections 133 of the grippers 132 is thereby removed.

As shown in FIG. 1, the probe unit 40 is disposed to be distanced from the clamping device main body 10 on a workpiece machining device 60 side of the clamping device main body 10. This probe unit 40 includes a probe main body 41 to which a touch sensor (not illustrated) is provided at a leading end side, and a probe drive unit 42 that causes this probe main body 41 to advance and retract relative to the clamping device main body 10.

According to the above probe unit 40, by causing the probe drive unit 42 to drive according to the control device 50, the probe main body 41 is forced to advance towards the cylinder head W clamped in the clamping device main body 10. In addition, contact between the probe main body 41 and the cylinder head W can be detected by way of the touch sensor provided at the leading end side of the probe main body 41.

The control device 50 controls the operations of the clamping device main body 10, clamp support device 20, washing device 30 and probe unit 40, and workpiece machining device 60. This control device 50 is configured to include a CPU (Central Processing Unit) that performs the processing of respective functions, memory that stores tables storing data, and programs executing each function, and the like.

More specifically, in a case of clamping the cylinder head W by the clamping device main body 10, the control device 50 causes the grip-section drive unit 14 to drive to make the first grip section 12 and second grip section 13 approach in a state having the clamping device main body 10 positioned in the horizontal state and arranging the cylinder head W inside of the frame body 11. The cylinder head W is thereby clamped by the grippers 122 and grippers 132. In addition, in a state having the clamping device main body 10 positioned in the horizontal state after machining has been conducted on the workpiece W, the control device 50 releases (unclamps) the clamping of the cylinder head W by the clamping device main body 10, by causing the first grip section 12 and the second grip section 13 to separate.

Furthermore, in a state attaching the clamping device main body 10 to the first table 21, the control device 50 causes the attitude of the clamping device main body 10 to change between the horizontal state in which the frame body 11 follows the horizontal direction (refer to FIG. 3), and the vertical state in which the frame body 11 follows the vertical direction (refer to FIG. 2), by causing the first table 21 to rotate about the first axis B, and causing the second table 22 to rotate about the second axis A.

Additionally, in a state positioning the clamping device main body 10 not clamping the cylinder head W in the horizontal state, the control device 50 causes the wash solution to be sprayed from the plurality of first wash solution spray units 31 towards the corresponding grippers 122, 132, respectively. Moreover, the wash solution is made to spray from the second wash solution spray unit 32 towards the plurality of grippers 132 of the second grip section 13.

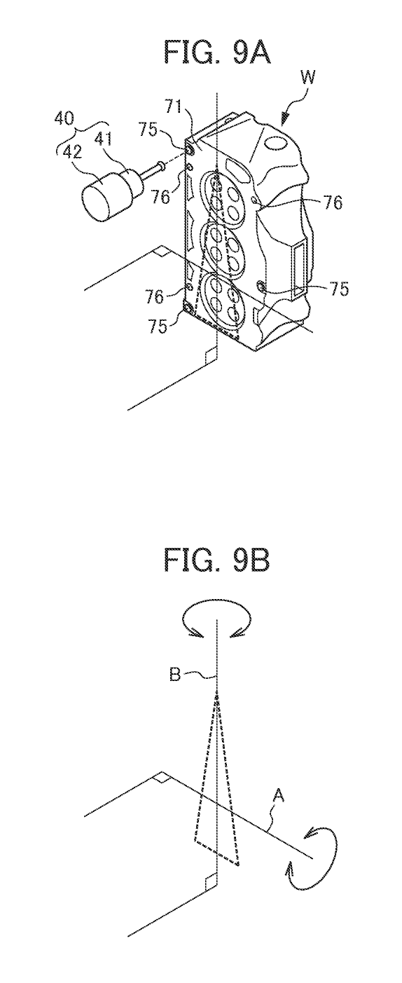

In addition, the control device 50 performs correction of the plane orientation of the machined surface of the cylinder head W clamped in the clamping device main body 10, and adjusting of the machining reference positions when conducting machining on the machined surface. In more detail, as a configuration for performing correction of the plane orientation of the machined surface of the cylinder head W, and adjusting of the machining reference position when conducting machining on the machined surface, the control device 50 includes a positional information acquisition part 51, plane orientation detection part 52, machined surface correction part 53, reference position detection part 54, and position adjustment part 55, as shown in FIG. 8.

Based on the contact positions between the probe unit 40 and a plurality of reference parts (reference seats 75 or reference holes 76), the positional information acquisition part 51 acquires positional information of this plurality of reference parts (reference seats 75 or reference holes 76).

The plane orientation detection part 52 detects the plane orientation of the machined surface of the cylinder head W, based on the positional information of the plurality of reference parts (reference seats 75) acquired by the positional information acquisition part 51.

The machined surface correction part 53 corrects the plane orientation of the machined surface based on the plane orientation of the machined surface of the cylinder head W detected by the plane orientation detection part 52.

The reference position detection part 54 detects the machining reference positions on the machined surface of the cylinder head W, based on the positional information of the plurality of reference parts (reference holes 76) acquired by the positional information acquisition part 51.

The position adjustment part 55 adjusts a machining initial position of the workpiece machining device 60, based on the machining reference positions detected by the reference position detection part 54.

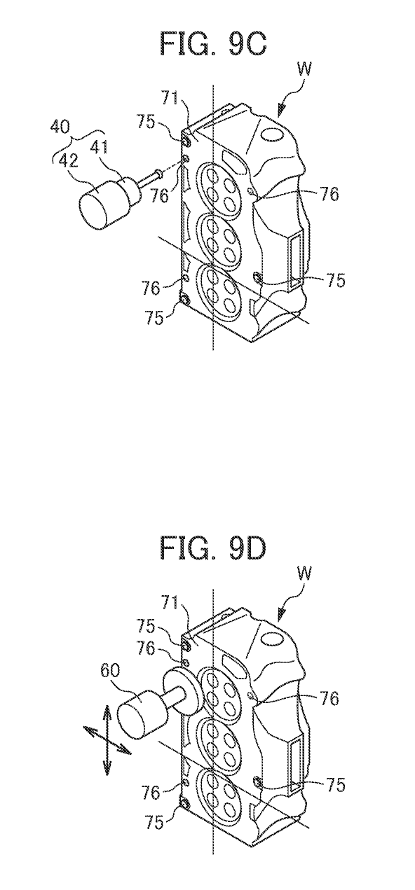

Next, the specific operations of the clamping device 1 when performing correction of the plane orientation of the machined surface of the cylinder head W and adjustment of the machining reference positions when conducting machining on the machined surface will be explained while referencing FIGS. 9A to 9D. FIG. 9A is a view showing a state of measuring the plane orientation of the first machined surface 71 of the cylinder head W clamped by the clamping device main body 10. FIG. 9B is a view showing a state of correcting the plane orientation of the first machined surface 71. FIG. 9C is a view showing a state of detecting the machining reference position of the cylinder head W for which the plane orientation of the first machined surface 71 has been corrected. FIG. 9D is a view showing a state of conducting, by way of the workpiece machining device 60, machining on the first machined surface 71 of the cylinder head W for which the machining reference position has been detected.

First, the control device 50 causes the clamping device main body 10 first in a state clamping the cylinder head W to be positioned in the vertical state and at a position at which the first machined surface 71 faces the workpiece machining device 60. Next, as shown in FIG. 9A, the control device 50 causes the probe drive unit 42 to drive to make the probe main body 41 to advance towards one reference seat 75 among the reference seats 75.

Next, when contact between the leading end of the probe main body 41 and the reference seat 75 is detected by the touch sensor, the positional information acquisition part 51 acquires positional information (coordinates) of the reference seat 75, based on the contact position between the probe main body 41 and reference seat 75. The control device 50 performs similar operations for each of the reference seats 75, and the positional information acquisition part 51 acquires positional information for each of the reference seats 75.

Next, the plane orientation detection part 52 detects the plane orientation of the first machined surface 71, based on the positional information of each of the reference seats 75 acquired by the positional information acquisition part 51.

The machined surface correction part 53 corrects the plane orientation of the first machined surface 71, based on information related to the plane orientation of the first machined surface 71 detected by the plane orientation detection part 52, and information related to the suitable plane orientation of the first machined surface 71 stored in advance in the control device 50.

In other words, with the present embodiment, due to clamping the cylinder head W by gripping from two directions by the first grip section 12 and the second grip section 13 of the clamping device main body 10, slight distortion or the like occurs in the first machined surface 71 of the cylinder head W after clamping. Therefore, with the present embodiment, as shown in FIG. 9B, the machined surface correction part 53 corrects the plane orientation of the first machined surface 71 by causing the clamp support device 20 to drive so that the plane orientation of the first machined surface 71 detected by the plane orientation detection part 52 matches the suitable plane orientation of the first machined surface 71 stored in advance in the control device 50.

Next, the control device 50 performs adjustment of the machining reference position. As shown in FIG. 9C, the control device 50 causes the probe main body 41 to advance towards one reference hole 76 among the reference holes 76 by causing the probe drive unit 42 to drive.

Next, when contact between the leading end of the probe main body 41 and the reference hole 76 is detected by the touch sensor, the positional information acquisition part 51 acquires positional information (coordinates) of the reference hole 76 based on the contact position between the probe main body 41 and the reference hole 76. The control device 50 performs similar operations for each of the reference holes 76, and the positional information acquisition part 51 acquires positional information for each of the reference holes 76.

Next, the reference position detection part 54 detects the machining reference position of the first machined surface 71 of the cylinder head W, based on the positional information of each of the reference holes 76 acquired by the positional information acquisition part 51. More specifically, the reference position detection part 54 specifies the coordinates of the machining reference position on the first machined surface 71 of the cylinder head W clamped by the clamping device main body 10 at which machining by the workpiece machining device 60 is initiated, from the coordinates of each of the reference holes 76 acquired by the positional information acquisition part 51, and the relationship between the positions of the reference holes 76 stored in advance in the control device 50 and the positions of the machining reference positions.

Next, as shown in FIG. 9D, the position adjustment part 55 adjusts the machining initial position of the workpiece machining device 60, based on the machining reference position of the first machined surface 71 detected by the reference position detection part 54. More specifically, the position adjustment part 55 makes the coordinates of the machining part of the workpiece machining device 60 match the coordinates of the machining reference position detected by the reference position detection part 54.

After the control device 50 has performed correction of the plane orientation of the first machined surface 71 of the cylinder head W and adjustment of the machining reference position of the first machined surface 71 in this way, predetermined machining is conducted on the first machined surface 71.

It should be noted that the control device 50 makes the second machined surface 72 face the workpiece machining device 60, by causing the first table 21 of the clamp support device 20 to rotate 180° about the first axis B, when machining on the first machined surface 71 by the workpiece machining device 60 is finished. Then, after the control device 50 has performed correction of the plane orientation of the second machined surface 72 and adjustment of the machining reference position of the second machined surface 72 in a similarly sequence to the aforementioned, predetermined machining is conducted on the second machined surface 72 by the workpiece machining device 60.

The following such effects are exerted according to the clamping device 1 of the present embodiment explained above.

(1) The clamping device 1 is configured to include the frame body 11, the first grip section 12 having the plurality of projections 123, and the second grip section 13 disposed to face this first grip section 12 and having the plurality of projections 133. Since the cylinder head W can thereby be clamped by gripping at the two locations of the first gripped surface 73 and the second gripped surface 74, neither of the first machined surface 71 and the second machined surface 72 are blocked by a jig pallet or the like. Therefore, the degrees of freedom of machining on the cylinder head W can be improved, and it becomes possible to machine two machined surfaces of the cylinder head W simultaneously or consecutively.

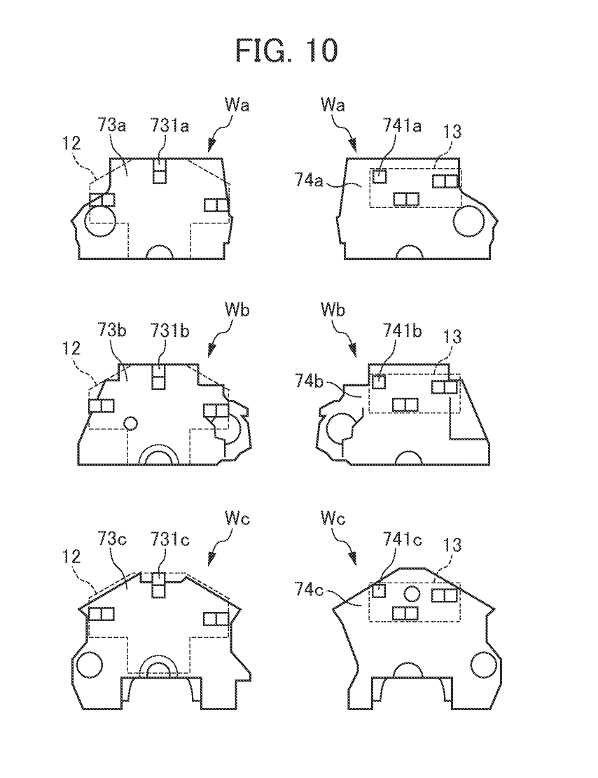

(2) The first grip section 12 and the second grip section 13 are made to be arranged facing, and the grip-section drive unit 14 is provided that causes the second grip section 13 to advance or retract in a direction approaching the first grip section 12 or a direction separating from the first grip section 12. Since the cylinder head W is gripped by causing the first gripping 12 and the second grip section 13 to approach, it is thereby possible to handle the cylinder heads Wa, Wb and We of various sizes and shapes, as shown in FIG. 10, for example, by adjusting the distance between the first grip section 12 and the second grip section 13 in accordance with the size and shape of the cylinder head W. Therefore, the degrees of freedom in handling shapes of cylinder heads W can be improved, and all-purpose equipment enabling flexible manufacturing can be realized for machining a wide variety of workpieces.

(3) The first grip section 12 is configured to include a plurality of projections 123, and the second grip section 13 is configured to include a plurality of projections 133. Therefore, since the gripping force on the cylinder head W by the first grip section 12 and the second grip section 13 can be raised, it is possible to improve the stability of the gripped state of the cylinder head W by the clamping device main body 10.

(4) The clamping device 1 is configured to include the clamp support device 20 that allows the clamping device main body 10 to rotationally drive to be changeable between a horizontal state and a vertical state. The clamping device main body 10 is thereby made to be positioned in the horizontal state, the cylinder head W is made to be clamped, this clamping device main body 10 is positioned in the vertical state, and machining is conducted on the first machined surface 71 and the second machined surface 72 by making. Therefore, after machining has been conducted on the first machined surface 71 by the workpiece machining device 60, machining is easily conducted on the second machined surface 72 by the same workpiece machining device 60 by causing the clamping device main body 10 to rotate 180° about the first axis B extending in the vertical direction; therefore, the layout of equipment on the production line of vehicles can be made more efficient. In addition, the time required in machining of the cylinder head W can be shortened.

(5) With the present embodiment, since the cylinder head W is clamped by gripping from two directions by the first grip section 12 and the second grip section 13 in the clamping device main body 10, slight distortion or the like occurs in the first machined surface 71 of the cylinder head W after clamping. Therefore, the machined surface correction part 53 corrects the plane orientation of the first machined surface 71 by causing the clamp support device 20 to drive so that the plane orientation of the first machined surface 71 detected by the plane orientation detection part 52 matches the suitable plane orientation of the first machined surface 71 stored in advance in the control device 50. Therefore, since machining is made to be conducted on the first machined surface 71 in a state correcting distortion or the like occurring in the first machined surface 71 of the cylinder head W due to clamping by the clamping device main body 10, it is possible to improve the precision of machining by the workpiece machining device 60.

(6) In the reference position detection part 54, the coordinates of the machining reference position on the first machined surface 71 of the cylinder head W clamped by the clamping device main body 10 at which machining by the workpiece machining device 60 is initiated are made to be specified based on the coordinates of each of the reference holes 76 acquired by the positional information acquisition part 51, and the relationship between the positions of the reference holes 76 stored in advance in the control device 50 and the positions of the machining reference positions, and in the position adjustment part 55, the coordinates of the machining part of the workpiece machining device 60 are made to match the coordinates of the machining reference position detected by the reference position detection part 54. Therefore, the precision of machining by the workpiece machining device 60 can be further improved.

(7) The clamping device 1 is configured to include the washing device configured to have the first wash solution spray units 31 and the second wash solution spray unit 32. Foreign contamination such as metal powder adhered to the plurality of projections 123, 133 of the grippers 122, 132 can thereby be removed by spraying the wash solution from the first wash solution spray units 31 and the second wash solution spray unit 33. Therefore, a decline in the gripping force on the cylinder head W by the grippers 122, 132 is prevented.

Although a preferred embodiment of the present invention has been explained above, the present invention is not to be limited to the aforementioned embodiment, and can be implemented in various forms.

For example, although the present invention has been applied to the clamping device 1 that clamps the cylinder head W serving as the workpiece in the present embodiment, it is not limited thereto. In other words, the present invention may be applied to clamping devices that clamp cylinder blocks or crank cases serving as the workpieces.

1. A clamping device for fixing a workpiece, the device comprising:
a frame body capable of surrounding the workpiece;
a first grip section disposed at an inner surface of the frame body and having a plurality of projections that project inwards;
a second grip section disposed at an inner surface of the frame body facing the inner surface on which the first grip section is disposed, and having a plurality of projections that project inwards; and
a grip-section drive unit that causes the first grip section and the second grip section to advance or retract in a direction approaching or a direction separating from each other.

2. The clamping device according to claim 1,
wherein the workpiece includes at least one machined surface, and a peripheral surface including a first gripped surface extending substantially perpendicular to the machined surface, and a second gripped surface that extends substantially perpendicular to the machined surface and substantially parallel to the first gripped surface,
wherein the frame body surrounds the peripheral surface of the workpiece,
wherein the first grip section is disposed to face the first gripped surface, and
wherein the second grip section is disposed to face the second gripped surface.

3. The clamping device according to claim 2, further comprising a frame body drive unit that is connected to the frame body, and causes the frame body to rotational drive to be changeable between a horizontal state in which the machined surface follows a horizontal direction and a vertical state in which the machined surface follows a vertical direction.

4. The clamping device according to claim 2,
wherein the workpiece includes a plurality of reference parts provided on the machined surface, and
wherein the clamping device further comprises:
a probe unit capable of contacting the plurality of reference parts by advancing and retracting relative to the machined surface; and
a positional information acquisition part that acquires positional information for each of the plurality of reference parts, based on contact positions between the probe unit and the plurality of reference parts.

5. The clamping device according to claim 4, further comprising:
a plane orientation detection part that detects a plane orientation of the machined surface based on the positional information acquired by the positional information acquisition part; and
a machined surface correction part that corrects the plane orientation of the machined surface based on the plane orientation detected by the plane orientation detection part.

6. The clamping device according to claim 4, further comprising:
a reference position detection part that detects a machining reference position on the machined surface based on the positional information acquired by the positional information acquisition part; and
a position adjustment part that adjusts a machining initial position of a workpiece machining device conducting machining on the machined surface, based on the machining reference position detected by the reference position detection part.

7. The clamping device according to claim 1, further comprising a washing unit that sprays a wash solution towards the first grip section and the second grip section.

8. The clamping device according to claim 1, wherein the first grip section and the second grip section are disposed asymmetrically relative to the workpiece.

9. A gripper for a clamping device, the gripper comprising a plurality of projections and fixing a workpiece by pressing by way of the plurality of projections.
